(19) United States
(12) Patent Application Publication
(10) Pub. No.: US 2002/0182049 A1
(43) Pub. Date: Dec. 5, 2002

(54) Device for preparing fluids for loading dispensing tools

(76) Inventor: David Gutig, Berlin (DE)

Correspondence Address: KRIEGSMAN & KRIEGSMAN, 665 FRANKLIN STREET, FRAMINGHAM, MA, 01702, US

(21) Appl. No.: 10/068,552

(22) Filed: Feb. 6, 2002

(30) Foreign Application Priority Data
Feb. 9, 2001 (DE) 101 07 517.0

(51) Int. Cl. B65G 1/00

(52) U.S. Cl. 414/787

(57) ABSTRACT

This involves a device for the random arrangement of vessels open at the top in a rectangular grid, whereby the grid of vessels is bounded at two opposite-lying sides by static side walls (B), between which it can be moved as a whole with the other two side walls (A) perpendicular thereto, and there is at least one position, at which the static side walls are perforated at opposite-lying places and at least one other vessel can be moved into the grid with a guide element (C), which simultaneously retracts on the opposite-lying side, in order to take up the vessel that has been moved out of the grid, and to move it again into the grid at another place, if necessary, and thus to successively permutate the vessels.

The invention concerns a device for preparing fluids for loading dispensing tools for the production of oligonucleotide chips.

It is known that for the production of oligonucleotide chips, the oligonucleotide solutions are prepared in so-called microtiter plates. Generally, glass plates are designated as oligonucleotide chips, such as, for example, the glass slides used for microscopy, onto which a defined grid of points with different oligonucleotides is introduced. This is done by placing specially prepared needles on the glass plates, which [needles] have previously been wetted by immersion in the respective oligonucleotide solutions. Other dispensing tools are also known and are used in a similar way. In order to achieve a higher throughput, devices are generally used, which can take up several dispensing tools, and thus permit dispensing from several points simultaneously. This makes it meaningful to prepare the oligonucleotide solutions in vessels, which are laid out in the same grid as the dispensing tools, and thus permit a simultaneous loading of all dispensing tools. It is prior art to collect the vessels in an injection-molded component, the microtiter plate, which also simplifies automatic filling and storage. In another process, the oligonucleotides are directly synthesized at the corresponding points on the glass plates. All oligonucleotides are comprised of chains of four of the samel building blocks [bases] and differ only in the sequence of these bases in the chain. In synthesizing, the bases in the respective series are introduced onto the points and thus the desired sequences are formed. Various coupling, washing and deprotecting steps are necessary between the individual dispensing steps, but these [other steps] are the same for all points and thus can be conducted simultaneously. In order to be able to synthesize different oligonucleotides on the points as desired, it is thus necessary to be able to load the dispensing tools with any combination of solutions of bases. According to the prior art, all combinations of solutions of bases are thus prepared in one or more microtiter plates. In the case of a moderate number of dispensing tools, this leads to an enormous space requirement and a high requirement for solutions of bases. A reduction in the number of dispensing tools or renouncing simultaneous loading, on the other hand, leads to prolonging of the synthesis, which, among other things, may lead to problems with the finite preservability of the prepared solutions.

The object of the present invention is thus to be able to randomly arrange a grid of vessels in order to prepare a grid with any combination of a finite number of fluids in a way that saves space and is economical, for the simultaneous loading of dispensing tools.

This object is solved by the features listed in the principal claim. Advantageous enhancements of the features according to the invention are characterized in the dependent subclaims.

This object is thus solved by a device for the random arrangement of vessels open at the top in a rectangular grid, wherein the grid of vessels is bounded on two sides lying opposite one another by static side walls (B), between which it [the grid] can be shifted as a whole with the other two side walls (A) perpendicular thereto, and at least one position is provided, at which the static side walls are perforated at opposite-lying places and at least one other vessel with a guide element (C) can be moved into the grid, which simultaneously retracts on the opposite-lying side, in order to take up the vessel moved out from the grid, and to move it into the grid again in another place, if necessary, and thus to successively permutate the vessels.

It is advantageous that the grid can be displaced as a whole on a slide between the static side walls.

It is further particularly advantageous that the slide is provided with grooves perpendicular to its direction of motion, and the vessels with corresponding pins are thus limited only to this direction of motion on the slide.

It is further preferred according to the invention that the vessels are cylinder-symmetric.

It is also preferred according to the invention that the modular size of the grid of vessels corresponds to the modular size of a grid of dispensing tools, which may be loaded simultaneously thereby.

The advantages obtained with the invention particularly consist of the minimum required number of vessels per fluid with simultaneous loading of a given number of dispensing tools with any combination of a given number of fluids. This leads to an efficient utilization of the fluids and to a small space requirement of the construction. In addition, the invention makes possible an expansion of current systems for producing oligonucleotide chips with presynthesized oligonucleotides to a system with which [oligonucleotides] can be directly synthesized on the glass plates.

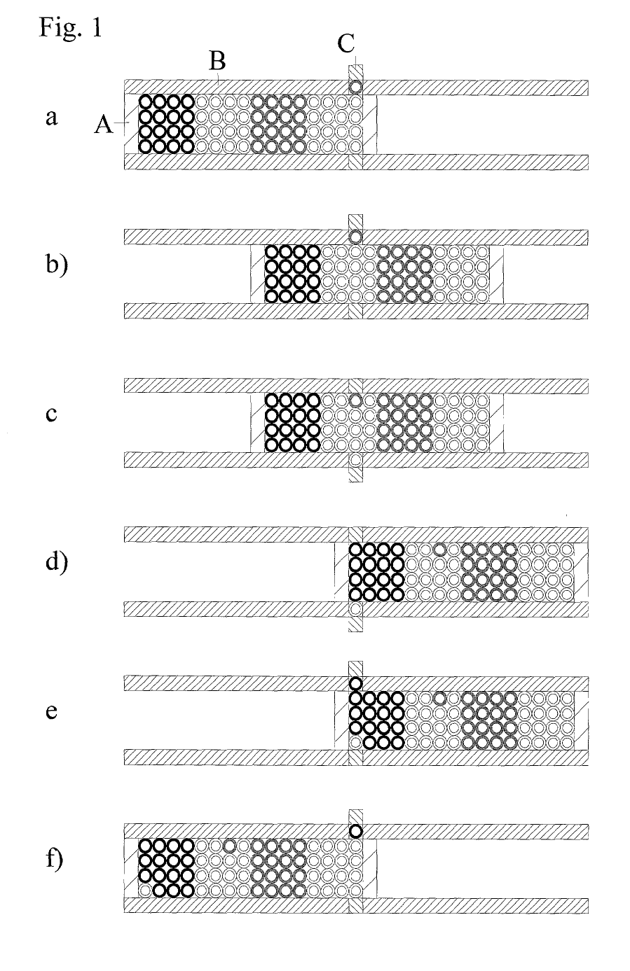

An advantageous configuration of the device according to the invention is shown in FIG. 1.

Here:

A indicates the slide with the grid of vessels;

B indicates the side walls for guiding the slide and for lateral stabilization of the vessels;

C indicates the exchange direction in which another vessel can be moved into the grid of vessels with a guide element and the vessel that is moved out is taken up on the other side.

An example of embodiment of the invention with which 4×4 dispensing tools can be loaded simultaneously with any combination of 4 different fluids is represented in FIG. 1 in top view. A slide A furnished with 64 vessels is guided horizontally by static side walls B, which most preferably provide also for the lateral stability of the grid of vessels. In order to stabilize the grid of vessels when the slide moves, the vessels are preferably provided with pins on the under side, which [pins] come to lie in corresponding grooves of the slide, which run perpendicular to the direction of motion of the slide. In order to avoid a tilting of the vessels, they are constructed as cylinders in a particularly preferred manner. The static side walls are perforated at a place C and another vessel can be moved into the grid by means of a guide element, whereby a vessel is moved out from the grid on the opposite-lying side and taken up. The lateral guide of the grid is achieved in a particularly preferred manner at this place on one side by the guide element and on the other side by the vessel that has been moved out.

In position a), for example, the dispensing tools can be simultaneously dipped into the vessels shown as black [circles]. The other positions b) to f) show an exemplary sequence, with which the dispensing tools can be loaded at the same place with another combination of fluids. For this purpose, the slide is brought into position b). By moving the guide element, a white vessel is moved out from the grid at position c). The slide is repositioned at position d) and the vessel is again moved at position e) into another place by back movement of the guide element. In position f) the slide is again brought to the initial position, where now the dispensing tools can be loaded with the new combination of fluids. Any combination of fluids can be prepared for the dispensing tools by a suitable sequence of movements of the slide and the guide element.

1. A device for the random arrangement of vessels open at the top in a rectangular grid, characterized in that the grid of vessels is bounded at two sides lying opposite one another by static side walls (B), between which it [the grid] can be moved as a whole with the other two side walls (A) perpendicular thereto, and there is at least one position, at which the static side walls are perforated at opposite-lying places and at least one other vessel can be moved with a guide element (C) into the grid, which simultaneously retracts on the opposite lying-side, in order to take up the vessel moved out from the grid, and to move it to another place in the grid again, if necessary, and thus to successively permutate the vessels.

2. The device according to claim 1, further characterized in that the grid can be moved as a whole on a slide between the static side walls.

3. The device according to claim 2, further characterized in that the slide is provided with grooves perpendicular to its direction of motion, and the vessels with corresponding pins are thus limited only to this direction of motion on the slide.

4. The device according to one of the preceding claims, further characterized in that the vessels are cylinder-symmetric.

5. The device according to one of the preceding claims, further characterized in that the modular dimension of the grid of vessels corresponds to the modular dimension of a grid of dispensing tools, which can thereby be loaded simultaneously.
